(19) United States
(12) Patent Application Publication
(10) Pub. No.: US 2026/0347113 A1
(43) Pub. Date: Nov. 5, 2026

(54) Methods and Systems for Automated Picking of Packages onto a Load Carrier

(71) Applicant: Swisslog AG, Buchs/Aarau (CH)

(72) Inventors: Stefan Kuppelwieser, Donauwoerth (DE); Jens Heitzmann, Scharbeutz (DE); Andreas Froehlich, Fuenfstetten (DE); Jens Bernd-Striebeck, Sprockhoevel (DE)

(73) Assignee: Swisslog AG, Buchs/Aarau (CH)

(21) Appl. No.: 19/559,124

(22) Filed: Mar. 6, 2026

(30) Foreign Application Priority Data
Mar. 10, 2025 (EP) 25162679

(51) Int. Cl. B65G 1/137; B65G 47/244; B65G 47/90; B65G 61/00

(52) U.S. Cl. CPC B65G 1/1378; B65G 47/244; B65G 47/90; B65G 61/00

(57) ABSTRACT

A method for automated picking of packages onto a load carrier incudes automatically creating a packing pattern for placing packages onto a predetermined load carrier based on a predetermined quantity of specific packages using a palletizing algorithm on an electronic computer, automatically sequencing the individual packages in a sequence suitable for assembling a stack of packages on the load carrier in the packing pattern and in an orientation of each individual package predetermined based on the packing pattern, and automatically transporting the packages in the sequenced order from a warehouse region to a picking workstation, where the transported packages are to be assembled onto the load carrier according to the packing pattern. At least one transported sequenced package is automatically reoriented during transport or when stationary between a preceding transport movement and a subsequent transport movement, about a first axis of rotation pointing in the direction of transport and/or about a horizontal second axis of rotation pointing transversely to the direction of transport.

### CROSS-REFERENCE TO RELATED APPLICATIONS

This application claims the benefit of priority under 35 U.S.C. § 119(a) to European Patent Application No. EP 25 162 679.2, filed Mar. 10, 2025, the disclosure of which is incorporated by reference herein in its entirety.

### TECHNICAL FIELD

The invention relates to a method for the automated picking of packages onto a load carrier, comprising the steps of automatically creating a packing pattern for placing packages onto a predetermined load carrier based on a predetermined quantity of specific packages by means of a palletizing algorithm on an electronic computer, automatically sequencing the individual packages of the predetermined quantity of specific packages in a sequence suitable for assembling a stack of packages on the load carrier in the created packing pattern and in an orientation of each individual package predetermined based on the created packing pattern, and automatically transporting the packages in the sequenced order from a warehouse region to a picking workstation, where the transported packages are to be assembled onto the load carrier according to the created packing pattern. The invention also relates to a corresponding picking system and an associated computer program product.

### BACKGROUND

DE 10 2009 011 287 A1 describes a heuristic method for the automated palletizing of stable stacks of packets, comprising the steps of virtually generating several successor configurations by adding packets to at least one initial configuration, evaluating these successor configurations, continuing with well-evaluated successor configurations as the initial configuration, and repeating these steps until a termination criterion is met, wherein the successor configurations are evaluated based on different sub-stack heights, towers, and/or superstructures.

### SUMMARY

An object of the invention is to create a method for the automated picking of packages onto a load carrier, with which a load carrier can be loaded quickly and without disruption with packages in a specific packing pattern. Other objects include providing a suitable picking system that can quickly and reliably load load carriers with packages in a specific packing pattern, and providing a suitable computer program product.

The object is achieved by a method for automated picking of packages on a load carrier, comprising the steps of:
automatically creating a packing pattern for placing packages on a predetermined load carrier based on a specified quantity of certain packages by means of a palletizing algorithm on an electronic computer,
automatically sequencing the individual packages of the predetermined quantity of specific packages in an order suitable for assembling a stack of packages on the load carrier in the created packing pattern and in an orientation of each individual package as predetermined based on the created packing pattern,
automatically transporting the packages in the sequenced order from a warehouse region to a picking workstation, where the transported packages are to be assembled on the load carrier according to the created packing pattern,
automatically reorienting at least one transported sequenced package during transport, about a first axis of rotation pointing in the direction of transport and/or about a horizontal second axis of rotation pointing transversely to the direction of transport.

In automated picking of packages, especially in the field of intralogistics, for example, based on a picking order, i.e., an order, a requested quantity of packages is automatically taken from at least one warehouse, automatically combined into an order and then loaded together onto a load carrier. The load carrier, which then contains the quantity of ordered packages, can finally be sent out for shipment.

The quantity of packages can be a single, identical number of packages of the same type of articles. The quantity of packages can also be a mixed number of different packages of different types of articles. The different types of articles can differ, for example, in the type of article, the retail size and/or in the number of single articles of a single type that are grouped together in a package. Different types of articles can result from different types of packaging.

The quantity of packages gathered based on a picking order can be assembled manually or automatically on the load carrier. The load carrier may be, for example, a pallet, in particular a transport pallet, a half pallet, a Euro pallet, a pallet according to US, ANZ and/or UK standards, or a roll container.

The load carrier can, for example, be a transport pallet according to the standard EN 13698-1. This can also be referred to as a Euro pallet (EPAL). It could be, in particular, a reusable transport pallet. The transport pallet may optionally be made of wood, metal or plastic. The transport load carrier is in particular designed to leave the warehouse or picking system in order to deliver the goods picked onto the transport load carrier from the warehouse of the picking system to a geographically distant customer by air, road and/or rail, according to the order. The shipping palletizing region thus forms the goods issue point of the picking system.

An alternative transport load carrier can also be a roll container, i.e., a roll container. Such roll containers can, for example, be designed according to the standard EN 12674-2. Such roll containers may comprise a base that is mobile on wheels, in particular swivel casters, which forms a storage surface for goods carriers and is laterally limited, for example, by two opposing wire mesh walls.

To assemble the quantity of packages gathered on the load carrier based on a picking order, palletizing algorithms are used, among other things, which run on an electronic computer and, depending on a predetermined individual quantity of packages, create a packing pattern, i.e., a rule for arranging the packages on the given load carrier in the form of package stacks and/or package towers.

The packing pattern for the number of packages can be optimized according to one or more different criteria. Exemplary criteria include the stability of the stacks or the tower against tipping, the maximization of the packing density of the stacks or tower on the load carrier, or the load-bearing capacity of individual packages to support further packages placed on top. A specific criterion by which the quantity of packages on a load carrier can be assembled in a sorted manner can be sorting the packages on the load carrier according to the order in which the load carriers with packages delivered from a logistics center of a retailer to an individual branch of the retailer, for example, are to be sorted into the store shelves there. Accordingly, it may be provided that the packages are arranged on the load carrier in such a way that a branch employee only has to push the delivered load carrier once in one direction along a row of shelves in the branch, wherein, for example, the packages to be placed first in the front store shelf at the beginning being arranged on the load carrier at the top of the tower, the packages to be placed in the store shelf in a middle section of the path along the store shelf being arranged at a middle height of the load carrier, and the packages to be placed in the store shelf at the end of the path along the store shelf being arranged at the lowest height of the load carrier. This would be an example of a customer-specific criterion for assembling a tower of packages on the load carrier.

The criteria for creating packing patterns may differ according to other market segments, such as Fast Moving Consumer Goods (FMCG), Food & Beverage and wholesalers, as well as all types of logistics service providers.

If a packing pattern is determined for the quantity of packages gathered on the basis of the picking order, the individual packages of the quantity of packages of the picking order are sequenced in a sequence in which the individual packages are to be placed one after the other on the load carrier in order to form the packing pattern with the packages on the load carrier.

The packages are taken from the warehouse and transported via a conveying device in the sequenced order to the picking workstation, where they are placed individually or in groups of several packages onto the load carrier according to the packing pattern by a transfer device. Placing the packages on the load carrier according to the packing pattern can, if necessary, be done manually instead of by means of an automatic transfer device.

The packing pattern not only specifies the position on the load carrier where the respective package is to be placed, but also specifies the orientation in which the respective package must be placed on the load carrier.

So far, it is known that the sequenced packages can be fed to the picking workstation either in a longitudinal direction or a transverse direction, depending on requirements. To rotate a package from the longitudinal direction to the transverse direction or from the transverse direction to the longitudinal direction, rotary tables are used, for example, which rotate the respective package by 90 degrees about a vertical axis of rotation.

According to the invention, it is now provided that the sequenced packages, or at least one package of the quantity of sequenced packages, are not only rotated about the vertical axis of rotation on their way from the warehouse to the picking workstation, but are also automatically reoriented about a first axis of rotation pointing in the direction of transport and/or about a horizontal second axis of rotation pointing transversely to the direction of transport. This can be advantageous in many application situations.

In addition to the well-known rotation of packages about a vertical axis of rotation, each package can also be reoriented about a first axis of rotation pointing in the direction of transport and/or about a horizontal second axis of rotation pointing transversely to the direction of transport. When reorienting about a first axis of rotation pointing in the direction of transport, the respective package is accordingly tilted sideways to the left or right with regard to the direction of transport. When reorienting about a horizontal second axis of rotation pointing transversely to the direction of transport, the respective package is accordingly turned forwards or backwards with regard to the direction of transport.

Each package can be reoriented in one or more of the three possible orientations, which can be the spatial orthogonal orientations or other orientations selected differently. This allows each package to be optimally oriented towards the load carrier or transfer device with regard to the packing pattern. This allows, for example, the respective package to be brought to the picking workstation in precisely the orientation in which it is to be placed on the load carrier. This eliminates the need to reorient the package, for example by the transfer device. Consequently, the transfer device may be designed to be simpler in construction, since it does not require a particular degree of rotational freedom to reorient a package arriving in the wrong orientation to the orientation required according to the packing pattern. In the case of manual transfer by a person, an ergonomically unfavorable turning movement is eliminated, which the person would have to perform if the package arrived in the wrong orientation and the person had to reorient the package. The term “picking workstation” also includes technical transfer points, such as pick-up/drop-off points.

Another application scenario is, for example, when a particular package is usually stored upright in the warehouse and is also supposed to be placed upright on the load carrier according to the packing pattern, but the upright orientation of the package is unfavorable for transport from the warehouse to the picking workstation and a horizontal transport would be more favorable, i.e., safer. For example, glass bottles in a bottle shipping carton should preferably be stored upright and also placed upright on a load carrier. However, transporting glass bottles in a bottle shipping carton on a conveying device in an upright orientation can be disadvantageous. For example, the glass bottles may bump into each other in an undesirable way during transport, or the entire bottle shipping carton may tip over in an undesirable way due to its high center of gravity, which in the worst case can lead to the destruction of the glass bottles. For such and similar packages, for example, transport in a horizontal position may be favorable.

Accordingly, a package coming from the warehouse that is in an initial orientation can be automatically reoriented to a transport orientation at the beginning of the transport route or at the beginning of the conveying device, then automatically transported in the transport orientation to the picking workstation, and subsequently automatically reoriented back to its initial orientation or to another delivery orientation according to the packing pattern at the end of the transport route or at the end of the conveying device.

On the other hand, with regard to warehousing, it may be advantageous to generally store packages or articles lying down in a warehouse, i.e., to store them in such an orientation that the smallest side length of the package runs vertically. For example, storage levels of a warehouse, such as a buffer warehouse, in particular a package buffer warehouse, or a temporary warehouse, such as a sequencer, can be installed with a lower height, which means that with the same overall height of the warehouse, especially a package buffer warehouse, additional storage levels can be created and thus more packages or articles can be kept in the warehouse.

Due to the new possibility, with the method step, of automatically reorienting at least one transported sequenced package during transport about a first axis of rotation pointing in the direction of transport and/or about a horizontal second axis of rotation pointing transversely to the direction of transport, a palletizing algorithm can take into account not only a single degree of rotational freedom for the respective packages, but also a second degree of rotational freedom and/or a third degree of rotational freedom for the respective packages during automatic packaging pattern generation. This results in significantly more combinatorial variants that can be considered within the framework of optimization algorithms to create an optimized packing pattern.

A further development of the method may thus provide that a reorientation of the at least one transported sequenced package takes place during transport from its initial orientation about the first axis of rotation pointing in the direction of transport and/or about the horizontal second axis of rotation pointing transversely to the direction of transport into an intermediate orientation, in which the reoriented package is transported further along an intermediate transport route and subsequently a reorientation of the at least one transported sequenced package about the first axis of rotation pointing in the direction of transport and/or about the horizontal second axis of rotation pointing transversely to the direction of transport into the initial orientation or into a transfer orientation different from the initial orientation and the intermediate orientation is carried out at the picking workstation.

The automatic reorientation of the at least one transported sequenced package during transport, about the first axis of rotation pointing in the direction of transport and/or about the horizontal second axis of rotation pointing transversely to the direction of transport, can be carried out by means of a reorientation apparatus which reorients the package to be reoriented during its transport movement or when stationary between a preceding transport movement and a subsequent transport movement on a conveying device. The automatic reorientation therefore does not necessarily have to take place during an actual movement of the package. Rather, the package can also be reoriented when stationary, at any point between the warehouse and the palletizing workstation, for example, on a table between an incoming conveying device and another outgoing conveying device. However, automatic reorientation can actually also occur while the package is in motion, for example when the package is moving on the conveying device and comes into contact with a fixed stop, which, due to the conveying movement of the package, causes the package to be turned over.

The conveying device may, for example, comprise at least one conveyor. The conveyor can, for example, be formed by a roller conveyor which comprises a large number of rotatable or rotationally drivable rollers spaced apart from each other in the conveying direction. However, the conveying device can also comprise at least one conveyor belt and/or at least one slide or table. The conveying device can also be formed by a plurality of vehicles, in particular, autonomously driving and/or autonomously navigating industrial trucks or rail-bound vehicles.

The reorientation apparatus can be, for example, a transfer unit, a tilting device or an adjustable approach stop, which intervenes in the transport and acts on the desired transported, sequenced package in order to automatically tilt or turn it about the first axis of rotation pointing in the direction of transport and/or about the horizontal second axis of rotation pointing transversely to the direction of transport during transport.

The reorientation apparatus can be an automatically handled gripper that lifts the package from the conveying device or grips it while supporting it on the conveying device and tilts it, reorients it by a gripping movement and places it back on the conveying device in the changed orientation. Accordingly, the package can be gripped, for example, by the gripper in an upper region of the package without the package being fully lifted, but only held in place and continued to be guided and/or rotated by the gripper with one edge of the package standing on the conveying device, for example to turn over a standing package or to stand up a lying package.

The gripper may be a mechanism positioned on the transport route that can perform one-dimensional or two-dimensional movements. Alternatively, the gripper may be attached to a tool flange of a multi-axis robot arm, with the joint angle configuration of the robot arm being automatically adjustable to move the gripper automatically in space. The gripper may, for example, be designed as a jaw gripper, which may comprise at least two gripper jaws that are automatically adjustable relative to each other, between which a package can be grasped in order to reorient the package by a corresponding movement of the gripper.

As an alternative to a reorientation apparatus, the automatic reorientation of the at least one transported sequenced package about the first axis of rotation pointing in the direction of transport and/or about the horizontal second axis of rotation pointing transversely to the direction of transport can be carried out by means of a transfer apparatus, which takes the package to be reoriented from a conveying device at the picking workstation in order to transfer it to the load carrier, and the transfer apparatus reorients the detected package during the transfer.

An automatically controlled robot arm can be used as the transfer apparatus, which removes the package from the conveying device, reorients the package by automatically changing the pose of the robot arm and places it on the conveying device or on the load carrier in the changed orientation.

A specific embodiment variant of the method may be characterized by the additional steps of:
automatically transporting the packages in the sequenced order and in a predetermined orientation of each individual package from a warehouse region to a picking workstation, where the transported packages are to be assembled on the load carrier according to the created packing pattern,
selecting at least one individual package from the sequenced order during the automatic transport of the packages and removing the at least one selected package from the transported sequenced order of packages,
automatically re-creating a modified packing pattern for placing the transported sequenced packages without the at least one selected package on the load carrier by means of the palletizing algorithm on the electronic computer under a recalculation of the orientation of the packages to be placed on the load carrier,
automatically reorienting the at least one transported sequenced package during transport according to the newly calculated orientation of the respective individual package.

Selecting at least one individual package from the sequenced order during the automatic transport of the packages and removing the at least one selected package from the transported sequenced order of packages may be necessary, for example, if an individual package is damaged during transport and therefore can no longer be placed on the load carrier.

Since a package intended for forming the stacks or tower on the load carrier according to the previous packing pattern is now missing, and the other packages are already on their way to the picking workstation and the previous packing pattern may no longer be able to be assembled, it may be useful to recalculate a modified packing pattern, based on a quantity of packages without the selected package.

However, since in such a case the sequenced order of the remaining packages is already fixed and thus predetermined when recalculating a new packing pattern, the possibilities for recalculating a new packing pattern are limited. According to the invention, when recalculating the new packing pattern, it is possible to take into account that each of the already sequenced packages is assigned a new orientation, which may be more favorable and a gap created by the failure of a particular package can be at least partially or even completely filled by the reoriented package. An resulting increase in the number of variants for the orientations of the already sequenced packages when creating a new packing pattern can at least partially or completely compensate for the limitations of the variants for packaging pattern formation due to the fixed sequence of the packages, or even allow for more variants for creating a new packaging pattern.

The automatic re-creation of the modified packing pattern for placing the transported sequenced packages without the at least one selected package on the load carrier can thus be carried out while maintaining the already sequenced order of the transported sequenced packages.

The object is also achieved by a picking system comprising a warehouse, a picking workstation with a load carrier, a reorientation apparatus and/or a transfer apparatus, as well as a conveying device designed for automatically transporting packages from the warehouse to the picking workstation and a picking control device with an electronic computer configured to automatically create packing patterns for placing packages on the load carrier by means of a palletizing algorithm, wherein the picking control device is designed and configured to carry out a method according to one of the described embodiments.

The object is also achieved by a computer program product comprising a machine-readable carrier on which a program code is stored, which can be read by a picking control device of a picking system, in particular a picking system according to any of the embodiments described, and which instructs and/or configures the picking control device to carry out a method according to any of the embodiments described when the program code is executed by the picking control device.

The computer program product can be a CD, a DVD, or a USB stick, for example. However, the computer program product can also be a control card on which microprocessors are integrated. However, the computer program product can also be implemented in the form of a download that can be offered and sold over the Internet or another network.

The machine-readable carrier can thus be a CD, a DVD, or a microprocessor on which the program code is stored. However, the machine-readable carrier can also be a hard disk or an SSD drive onto which the program code has been downloaded, e.g., by means of a download-in particular, in the form of data packets.

The program code may be represented by an edited program and/or data stored on the machine-readable carrier.

By reading out the edited program and/or the data, the picking control device reading it out is designed and/or configured to be able to carry out the method according to the invention by controlling the picking system according to the invention to reorient the packages accordingly.

Specific embodiments of the invention are explained in more detail in the following description with reference to the accompanying drawings. Specific features of these exemplary embodiments, possibly considered individually or in further combinations, can represent advantageous features of alternative embodiment variants of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a flowchart of steps in a basic exemplary method according to principles of the invention,

FIG. 2 is a flowchart of steps in a specific embodiment variant of the method according to principles of the invention,

FIG. 3 shows a schematic representation of an exemplary picking system according to principles of the invention with an exemplary package during its transport on a conveying device with a reorientation apparatus that reorients the package about a first axis of rotation pointing in the direction of transport on the conveying device,

FIG. 4 shows a schematic representation of the exemplary picking system according to principles of the invention with the exemplary package during its transport on the conveying device with the reorientation apparatus, which reorients the package about a horizontal second axis of rotation on the conveying device pointing transversely to the direction of transport, and

FIG. 5 shows a schematic representation of an exemplary picking system according to principles of the invention with an exemplary package during a transfer from the conveying device to a load carrier by means of a transfer apparatus designed as a robot arm with a reorientation of the package to be transferred about the first axis of rotation pointing in the direction of transport and/or about the horizontal second axis of rotation pointing transversely to the direction of transport.

### DETAILED DESCRIPTION

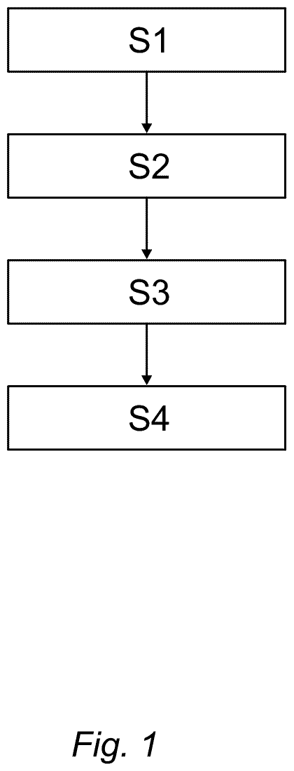

In FIG. 1, the steps of a basic exemplary inventive method for the automated picking of packages 1 onto a load carrier 2 are illustrated by means of a schematic flowchart.

In a first method step S1, a packing pattern for placing packages 1 on a predetermined load carrier 2 is automatically created based on a predetermined quantity of certain packages 1 by means of a palletizing algorithm on an electronic computer 3.

In a second method step S2, the individual packages 1 of the predetermined quantity of specific packages 1 are automatically sequenced in an order suitable for assembling a stack of packages 1 on the load carrier 2 in the created packing pattern and in an orientation of each individual package 1 predetermined based on the created packing pattern.

In a third method step S3, the packages 1 are automatically transported in the sequenced order from a warehouse region 4 to a picking workstation 5, where the transported packages 1 are to be assembled on the load carrier 2 according to the created packing pattern.

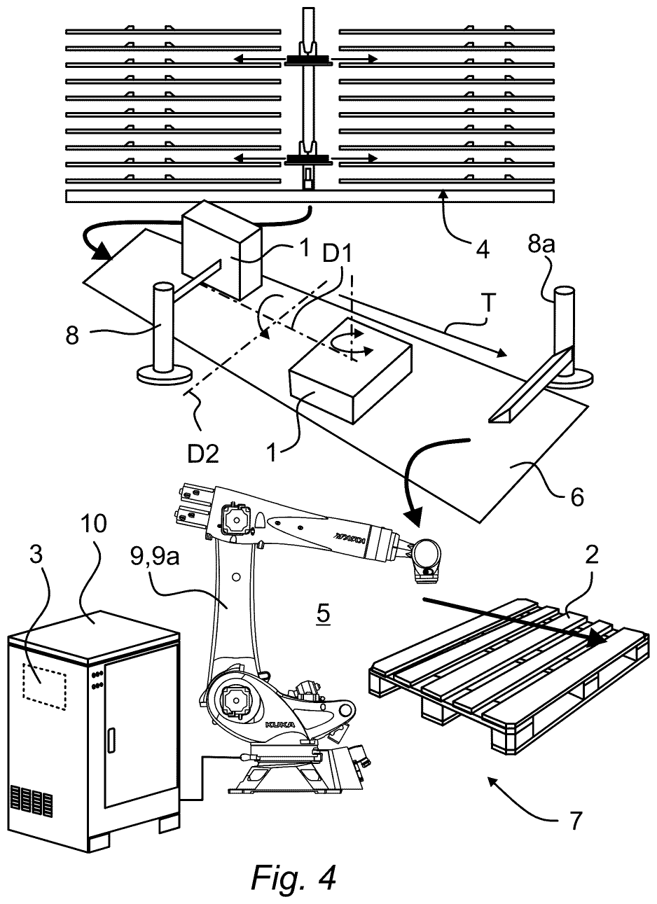

In a fourth method step S4, at least one transported sequenced package 1 is automatically reoriented during transport or when stationary between a preceding transport movement and a subsequent transport movement, for example on a conveying device 6, about a first axis of rotation D1 (FIG. 4) pointing in the direction of transport T and/or about a horizontal second axis of rotation D2 pointing transversely to the direction of transport T.

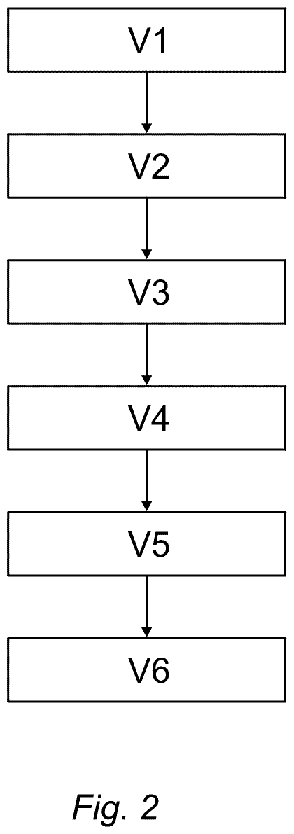

In FIG. 2, the steps of the particular embodiment variant of the method for the automated picking of packages 1 onto a load carrier 2 are illustrated by means of a further schematic flowchart.

In a first method step V1 of the particular embodiment variant of the method, a packing pattern for placing packages 1 on a predetermined load carrier 2 is automatically created based on a predetermined quantity of specific packages 1 by means of a palletizing algorithm on an electronic computer 3.

In a second method step V2 of the particular embodiment variant of the method, the individual packages 1 of the predetermined quantity of specific packages 1 are automatically sequenced in an order suitable for assembling a stack of packages 1 on the load carrier 2 in the created packing pattern and in an orientation of each individual package 1 predetermined based on the created packing pattern.

In a third method step V3 of the particular embodiment variant of the method, the packages 1 are automatically transported in the sequenced order and in a predetermined orientation of each individual package 1 from a warehouse region 4 to a picking workstation 5, where the transported packages 1 are to be assembled on the load carrier 2 according to the created packing pattern.

In a fourth method step V4 of the particular embodiment variant of the method, at least one individual package 1 is selected from the sequenced order during the automatic transport of the packages 1 and the at least one selected package 1 is removed from the transported sequenced order of packages 1.

In a fifth method step V5 of the particular embodiment variant of the method, a modified packing pattern for placing the transported sequenced packages 1 without the at least one selected package 1 on the load carrier 2 is automatically recreated by means of the palletizing algorithm on the electronic computer 3 under a recalculation of the orientation of the packages 1 to be placed on the load carrier 2.

In a sixth method step V6 of the particular embodiment variant of the method, the at least one transported sequenced package 1 is automatically reoriented during transport according to the newly calculated orientation of the respective individual package 1.

The automatic re-creation of the modified packing pattern for placing the transported sequenced packages 1 without the at least one selected package 1 on the load carrier 2 can be carried out, in particular, while maintaining the already sequenced order of the transported sequenced packages 1.

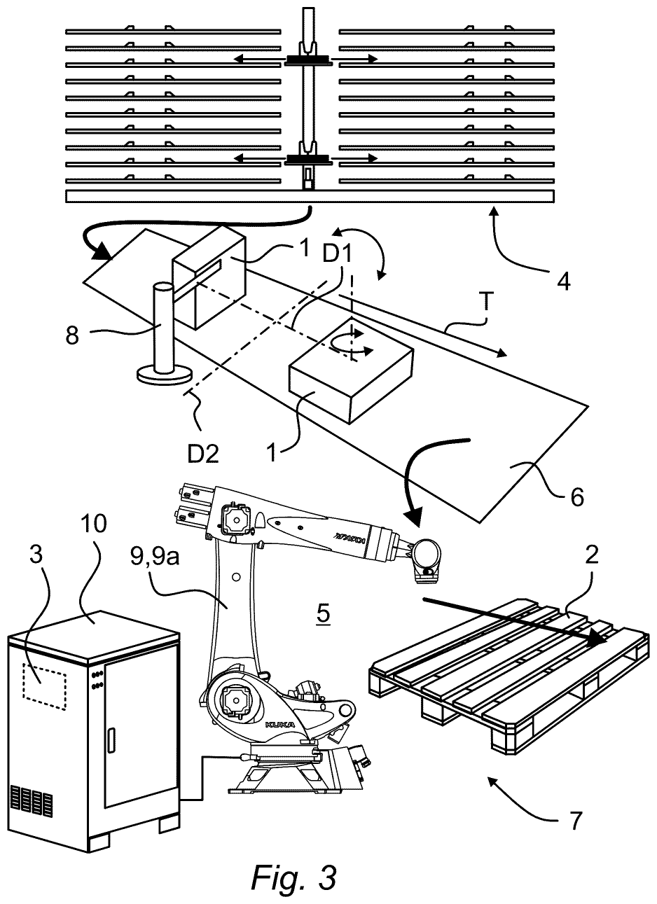

FIGS. 3 to 5 schematically show a picking system 7 comprising a warehouse 4, a picking workstation 5 with a load carrier 2, a reorientation apparatus 8 and/or a transfer apparatus 9, which in the illustrated embodiment can be a robot arm 9a, as well as a conveying device 6, which is designed for automatically transporting packages 1 from the warehouse 4 to the picking workstation 5.

The picking system 7 also comprises a picking control device 10 with an electronic computer 3, which is configured to automatically create packing patterns for placing packages 1 on the load carrier 2 by means of a palletizing algorithm, wherein the picking control 10 is designed and configured to carry out a method according to any of the described embodiments.

The reorientation device 8 can be designed and configured to reorient the at least one transported sequenced package 1 during transport from its initial orientation about the first axis of rotation D1 pointing in the direction of transport T and/or about the horizontal second axis of rotation D2 pointing transversely to the direction of transport T into an intermediate orientation in which the reoriented package 1 is transported further along an intermediate transport route.

By means of a further reorientation device 8a, a further reorientation of the at least one transported sequenced package 1 about the first axis of rotation D1 pointing in the direction of transport T and/or about the horizontal second axis of rotation D2 pointing transversely to the direction of transport T into the initial orientation or into a transfer orientation different from the initial orientation and the intermediate orientation can then be carried out by the reorientation device 8a at the picking workstation 5.

The automatic reorientation of the at least one transported sequenced package 1 during transport, about the first axis of rotation D1 pointing in the direction of transport T and/or about the horizontal second axis of rotation D2 pointing transversely to the direction of transport T, can be carried out by means of the reorientation device 8, which reorients the package 1 to be reoriented during its transport movement on the conveying device 6.

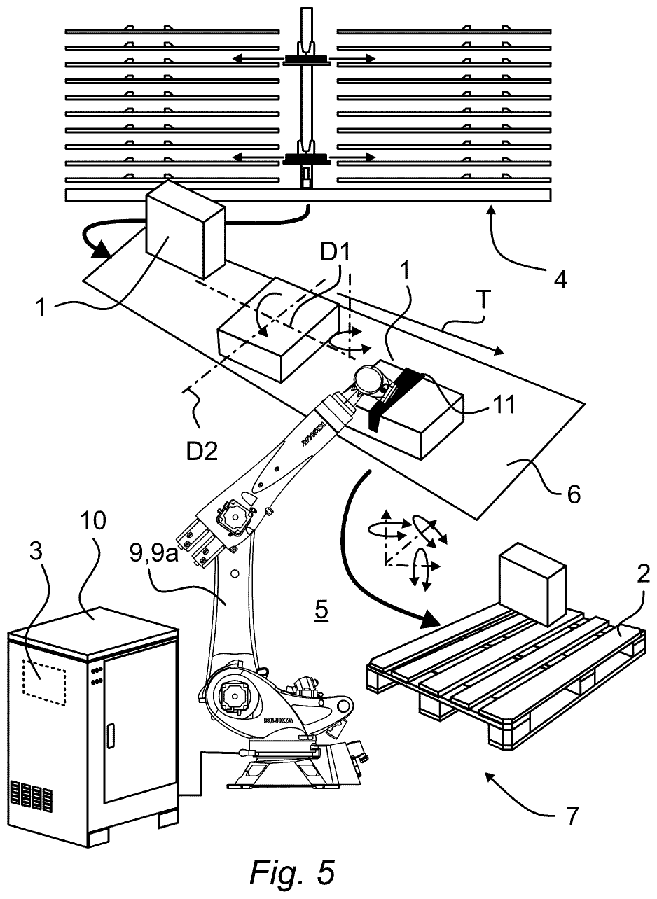

As shown schematically in FIG. 5, an automatically handled gripper 11 can be used as the reorientation device 8 or the further reorientation device 8a, which lifts the package 1 from the conveying device 6, reorients it by a gripping movement and places it back on the conveying device 6 in the changed orientation.

The automatic reorientation of the at least one transported sequenced package 1 about the first axis of rotation D1 pointing in the direction of transport T and/or about the horizontal second axis of rotation D2 pointing transversely to the direction of transport T can thus also be carried out by means of the transfer apparatus 9, which in the present embodiment is a robot arm 9a, which takes the package 1 to be reoriented from the conveying device 6 at the picking workstation 5 in order to transfer it to the load carrier 2, wherein the robot arm 9a reorients the detected package 1 during the transfer.

The transfer apparatus 9 can therefore be an automatically controlled robot arm 9a, which removes the package 1 from the conveying device 6, reorients the package 1 by automatically changing the pose of the robot arm 9a and places it on the load carrier 2 in the changed orientation.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A method for automated picking of packages (1) onto a load carrier (2), comprising the steps of:
automatically creating a packing pattern for placing packages (1) on a predetermined load carrier (2) based on a predetermined quantity of specific packages (1) by means of a palletizing algorithm on an electronic computer (3),
automatically sequencing the individual packages (1) of the predetermined quantity of specific packages (1) in an order suitable for assembling a stack of packages (1) on the load carrier (2) in the created packing pattern and in an orientation of each individual package (1) predetermined based on the created packing pattern,
automatically transporting the packages (1) in the sequenced order from a warehouse region to a picking workstation (5), where the transported packages (1) are to be assembled on the load carrier (2) according to the created packing pattern,
automatically reorienting at least one transported sequenced package (1) during transport about a first axis of rotation (D1) pointing in the direction of transport (T) and/or about a horizontal second axis of rotation (D2) pointing transversely to the direction of transport (T).

2. The method according to claim 1, characterized by reorienting the at least one transported sequenced package (1) during transport, or when stationary between a preceding transport movement and a subsequent transport movement, from its initial orientation about the first axis of rotation (D1) pointing in the direction of transport (T) and/or about the horizontal second axis of rotation (D2) pointing transversely to the direction of transport (T) into an intermediate orientation, in which the reoriented package (1) is transported further along an intermediate transport route and subsequently a reorientation of the at least one transported sequenced package (1) about the first axis of rotation (D1) pointing in the direction of transport (T) and/or about the horizontal second axis of rotation (D2) pointing transversely to the direction of transport (T) into the initial orientation or into a transfer orientation different from the initial orientation and the intermediate orientation is carried out at the picking workstation (5).

3. The method according to claim 1, characterized in that the automatic reorientation of the at least one transported sequenced package (1) during transport about the first axis of rotation (D1) pointing in the direction of transport (T) and/or about the horizontal second axis of rotation (D2) pointing transversely to the direction of transport (T) is carried out by means of a reorientation device (8) which reorients the package (1) to be reoriented during its transport movement or when stationary between a preceding transport movement and a subsequent transport movement on a conveying device (6).

4. The method according to claim 3, characterized in that an automatically handled gripper (11) is used as the reorientation device (8), which lifts the package (1) from the conveying device (6) or grips it while supporting it on the conveying device (6) and tilts it, reorients it by a gripping movement and places it back on the conveying device (6) in the changed orientation.

5. The method according to claim 1, characterized in that the automatic reorientation of the at least one transported sequenced package (1) about the first axis of rotation (D1) pointing in the direction of transport (T) and/or about the horizontal second axis of rotation (D2) pointing transversely to the direction of transport (T) is carried out by means of a transfer device (8) which takes the package (1) to be reoriented from a conveying device (6) at the picking workstation (5) in order to transfer it to the load carrier (2), and the transfer apparatus (8) reorients the detected package (1) during the transfer.

6. The method according to claim 5, characterized in that an automatically controlled robot arm (9a) is used as the transfer apparatus (8), which removes the package (1) from the conveying device (6), reorients the package (1) by automatically changing the pose of the robot arm (9a) and places it in the changed orientation onto the conveying device (6) or onto the load carrier (2).

7. The method according to claim 1, characterized by the additional steps of:
automatically transporting the packages (1) in the sequenced order and in a predetermined orientation of each individual package (1) from a warehouse region (4) to a picking workstation (5), where the transported packages (1) are to be assembled on the load carrier (2) according to the created packing pattern, selecting at least one individual package (1) from the sequenced order during the automatic transport of the packages (1) and removing the at least one selected package (1) from the transported sequenced order of packages (1),
automatically re-creating a modified packing pattern for placing the transported sequenced packages (1) without the at least one selected package (1) on the load carrier (2) by means of the palletizing algorithm on the electronic computer (3) under a recalculation of the orientation of the packages (1) to be placed on the load carrier (2),
automatically reorienting the at least one transported sequenced package (1) during transport according to the newly calculated orientation of the respective individual package (1).

8. The method according to claim 7, characterized in that the automatic re-creation of the modified packing pattern for placing the transported sequenced packages (1) is carried out without the at least one selected package (1) on the load carrier (2) while maintaining the already sequenced order of the transported sequenced packages (1).

9. A picking system (7) comprising a warehouse (4), a picking workstation (5) with a load carrier (2), a reorientation apparatus (8) and/or a transfer apparatus (9), as well as a conveying device (6) designed for automatically transporting packages (1) from the warehouse (4) to the picking workstation (5) and a picking control device (10) with an electronic computer (3) configured to automatically create packing patterns for placing packages (1) on the load carrier (2) by means of a palletizing algorithm, wherein the picking control device (10) is designed and configured to carry out a method according to claim 1.

10. A computer program product comprising a machine-readable carrier, on which a program code is stored, which can be read by a picking control device (10) of a picking system (7), in particular a picking system (7) according to claim 9, and which instructs and/or configures the picking control device (10) to implement a method according to claim 1 when the program code is executed by the picking control device (10).
